(19) United States
(12) Patent Application Publication
(10) Pub. No.: US 2016/0038264 A1
(43) Pub. Date: Feb. 11, 2016

(54) LOCKABLE TENSIONING FLOSSER

(71) Applicant: Sacks Holdings, Inc., Solana Beach, CA (US)

(72) Inventors: Devin S. Chodorow, Rancho Santa Fe, CA (US); Ingram S. Chodorow, Rancho Santa Fe, CA (US)

(21) Appl. No.: 14/546,927

(22) Filed: Nov. 18, 2014

Related U.S. Application Data
(60) Provisional application No. 62/036,033, filed on Aug. 11, 2014.

(51) Int. Cl. A61C 15/04

(52) U.S. Cl. CPC A61C 15/046

(57) ABSTRACT

A lockable tensioning flosser is disclosed herein. The lockable tensioning flosser includes a flosser having a flossing head. The flossing head can include a link arm, a first arm connected to the link arm, a second arm pivotably connected to the link arm, and a filament, that can be tensionable, extending between the first arm and the second arm. The second arm can be moved from a first position to a second position to affect the tension of the filament. The second arm can be locked in one or several positions to secure a constant filament tension.

### CROSS-REFERENCES TO RELATED APPLICATIONS

This application claims the benefit of U.S. Provisional Application No. 62/036,033 entitled “LOCKABLE TENSIONING FLOSSER,” and filed on Aug. 11, 2014, the entirety of which is hereby incorporated by reference herein.

### BACKGROUND

The present disclosure relates, generally, to dental devices, and more particularly to dental hygiene devices.

While dental hygiene has long been important in American and other cultures for maintaining a desirable physical appearance, recent discoveries have increased the urgency with which dental hygiene is maintained. These recent discoveries have linked oral bacteria to other, more serious disease such as, for example, heart disease. In light of the increased importance of dental hygiene, new devices are desired to improve dental hygiene.

### BRIEF SUMMARY

One aspect of the present disclosure relates to a dental flosser. The dental flosser can include a flossing head having a first arm extending in a first direction, a second arm extending in the first direction, a linking arm connecting the first arm and the second arm, and a filament extending from the first arm to the second arm. In some embodiments, the first arm and the second arm are movable from a first relative position to a second relative position to thereby adjust a tension of the filament from a first tension to a second tension. In some embodiments, the filament is loose at the first tension and taut at the second tension. In some embodiments, the first and second arms are lockable in the second relative position.

In some embodiments, the first arm has a first end connecting to the linking arm, and a second end from which the filament extends. In some embodiments, the second arm has a first end connecting to the linking arm, and a second end from which the filament extends. In some embodiments, the first end of the second arm is pivotably connected to the linking arm. In some embodiments, the first arm and the second arm are movable from the first relative position to the second relative position by rotationally displacing the second end of the second arm about the pivotable connection of the first end of the second arm to the linking arm.

In some embodiments, the first arm and the second arm are separated by a first distance when in the first position and the first arm and the second arm are separated by a second distance when in the second position. In some embodiments, the second distance is approximately 15 percent larger than the first distance. In some embodiments, the first and second arms are repeatably lockable in the second relative position, and the first and second arms can be released from the locked, second relative position.

One aspect of the present disclosure relates to a dental flosser. The dental flosser can include a flossing head having a linking arm, a first arm rigidly connecting to the linking arm and extending in a first direction from the linking arm, a second arm with a compliant joint, which second arm can be connected to the linking arm via the compliant joint. In some embodiments, the second arm extends from the linking arm in the first direction, and in some embodiments, the second arm is moveable from a first position to a second position. The dental flosser can include a filament extending from the first arm to the second arm. In some embodiments, a tension of the filament is adjustable from a first tension to a second tension when the second arm is moved from the first position to the second position.

In some embodiments, the second arm has a first end connecting to the linking arm via the compliant joint, and a second end from which the filament extends. In some embodiments, the second arm is movable from the first position to the second position by rotationally displacing the second end of the second arm about the compliant joint connecting the first end of the second arm to the linking arm. In some embodiments, the first arm and the second arm are separated by a first distance when the second arm is in the first position and the first arm and the second arm are separated by a second distance when the second arm is in the second position. In some embodiments, the second distance is between 0 and 20 percent larger than the first distance and/or approximately 15 percent larger than the first distance.

In some embodiments the dental flosser can include a locking element that can secure the second arm in the second position. In some embodiments, the locking element can releasably secure the second arm in the second position. In some embodiments, the second arm can further include a lever connecting to the second arm via a first end.

In some embodiments, the dental flosser can include a handle extending from the linking arm. In some embodiments, a first portion of the locking element can be located at a second end of the lever arm and a second portion of the locking element can be located on the handle. In some embodiments, a first portion of the locking element can be one of a ball and a socket, and in some embodiments, the second portion of the locking element can be the other of the ball and the socket.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a front view of one embodiment of a lockable tensioning flosser.

FIG. 2 is a perspective view of another embodiment of a lockable tensioning flosser.

FIG. 3 is a front view of another embodiment of a lockable tensioning flosser.

FIG. 4 is a close-up perspective view of one embodiment of features of the lockable tensioning flosser.

In the appended figures, similar components and/or features may have the same reference label. Where the reference label is used in the specification, the description is applicable to any one of the similar components having the same reference label

### DETAILED DESCRIPTION

In some embodiments, the present disclosure relates to a lockable tensioning flosser, that can, in some embodiments, include one or several integral and/or attached picks. In some embodiments, the lockable tensioning flosser can be configured to allow adjustment of the tension of a flossing filament that can be, in some embodiments, a lubricious filament. This ability to adjust the tension of the flossing filament can facilitate in the use of the lockable tensioning flosser, as a slack filament is difficult to use in a flossing application.

In some embodiments, the lockable tensioning flosser can include one or several features that allow the locking of the filament in a tension status. In one particular embodiments, the lockable tensioning flosser can allow the locking of the filament in a taut tension status. This locking can be achieved through one or several locking features that can be positioned on various portions of the lockable tensioning flosser including, for example, on a flossing head, on an arm, and/or on a handle. In some embodiments, these locking features can allow the unlocking of the filament from the tension status, and in some embodiments, these locking features can allow the repeated locking/unlocking of the filament in/from the tension status.

In some embodiments, the lockable tensioning flosser can include one or several picks. These one or several picks can be integral to the lockable tensioning flosser, and/or attachable to the lockable tensioning flosser. In some embodiments, these can be integral to and/or attached to the flossing head and/or the handle of the lockable tensioning flosser. The one or several picks can increase the usefulness of the lockable tensioning flosser in maintaining dental hygiene by allowing additional cleaning in the interproximal space between human teeth.

In some embodiments, the lockable tensioning flosser can include a bite plate that can be, for example, located on the flossing head of the lockable tensioning flosser. The bite plate can facilitate in maintaining dental hygiene by allowing a user to apply a force to the flossing head by biting on the bite plate. This force can be transferred to a filament of the bite plate, and can facilitate in bringing the filament into the interproximal space between human teeth. In some embodiments, this bite plate can further increase the stiffness of the flossing head.

For the purposes of explanation, the ensuing details are set forth in order to provide a thorough understanding of various embodiments. It will be apparent, however, to one skilled in the art that various embodiments may be practiced without some of these specific details. For example, various features may be shown as components of some specific embodiments. In other instances, previously known features may be shown without unnecessary detail in order to avoid obscuring the inventive features of the described embodiments.

Embodiments provided herein are examples only, and are not intended to limit the scope, applicability, or configuration of the disclosure. Rather, the ensuing description of the embodiments will provide those skilled in the art with an enabling description for implementing one or more embodiments. It should be understood that various changes may be made in the function and arrangement of elements without departing from the spirit and scope of the disclosed embodiments.

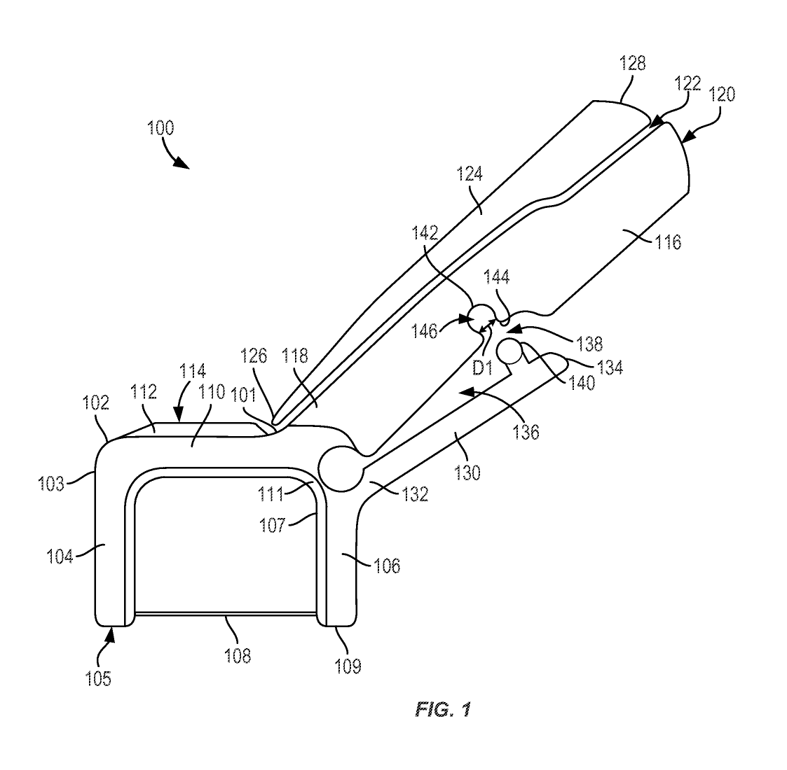

With reference now to FIG. 1, a front view of one embodiment of a lockable tensioning flosser 100 is shown. The lockable tensioning flosser 100 can comprise a variety of shapes and sizes. In some embodiments, the lockable tensioning flosser 100 can be sized so as to be easily held in a hand and to be used within a mouth. The lockable tensioning flosser 100 can be made from a variety materials. In some embodiments, the lockable tensioning flosser 100 can be made from one or several plastics, metals, composites, polymers, or the like. In some embodiments, the materials for the lockable tensioning flosser 100 are selected based on desired properties of a lockable tensioning flosser 100 and/or of the specific portion of the lockable tensioning flosser 100.

The lockable tensioning flosser 100 can include a flosser 101. The flosser 101 includes a flossing head 102, also referred to herein as the flossing portion. The flossing head 102 can include features configured to facilitate use of the lockable tensioning flosser 100 in flossing teeth. The flossing head 102 can comprise a variety of shapes and sizes but should be sized and shaped so as to allow a user to access all of the teeth in the user's mouth, and particularly the teeth located in the rear of the mouth.

The flossing head 102 can include a first arm 104, also referred to herein as the leading arm 104, and a second arm 106, also referred to herein as the trailing arm 106. In some embodiments, the first arm 104 can be located at the front of the flossing head 102 and/or of the flosser 101 and the second arm 106 can be relatively more centrally located in the flosser 101. In some embodiments, the leading arm 104 and the trailing arm 106 are parallel, and in some embodiments, the leading arm 104 and the trailing arm 106 are nonparallel. In some embodiments, the first and second arms 104, 106 can extend in the same direction. In some embodiments, the first and second arms 104, 106 extend in the same direction if they are parallel, and in some embodiments, the first and second arms 104, 106 extend in the same direction if a component of the extension of the first and second arms 104, 106 is parallel.

In some embodiments, the first arm 104 and the second arm 106 both extend from a link arm 110 and are connected by a filament 108. In some embodiments, one or both of the first and second arms 104, 106 can be rigidly connected to the link arm 110, and in some embodiments, one or both of the first and second arms 104, 106 can be flexibly connected to the link arm 110. In some embodiments, the first arm 104 can have a first end 103 connecting to the link arm 110 and the filament 108 can extend from a second end 105, and the second arm 106 can have a first end 107 connecting to the link arm 110, and the filament 108 can extend from a second end 109.

In some embodiments, the filament 108, which can be tensionable and/or under tension, can be moved from a first tension to a second tension, which can include, for example, movement from a first slack, or loose tension/tension position to a second, relatively tauter and/or taut tension/tension position. In some embodiments, this tensioning of the filament 108 can be achieved by the relative movement of the first and second arms 104, 106. In some embodiments, the first and second arms 104, 106 can be moved from a first position and/or relative position to a second position and/or relative position. In some embodiments, this can be achieved by movement of one or both of the first and second arms 104, 106.

In some embodiments, the degree to which the first and second arms 104, 106 are moved with respect to each other can depend on the desired degree of tensioning of the filament 108. This desired degree of tensioning can, in some embodiments, vary based on the material of the filament 108. Thus, in one embodiment, the movement of the first and second arms 104, 106 from the first position to the second position can increase the distance between he first and second arms 104, 106 spanned by the filaments by between 0% and 20%, between 1% and 5%, between 2% and 4%, between 10% and 20%, between 12% and 18%, between 14% and 16%, by approximately 3%, by approximately 5%, by approximately 7%, by approximately 10%, by approximately 13%, by approximately 15%, by approximately 17%, by approximately 20%, by approximately 23%, by approximately 25%, by approximately 27%, by approximately 30%, and/or any other or intermediate value. Thus, in some embodiments, the first and second arms 104, 106 can be moved from a first distance with respect to each other, to a second distance with respect to each other. In some embodiments, and as used above, “approximately” can mean a measurement +/−3%, +/−2%, +/−1%, +/−0.5%, +/−0.1% and/or any other or intermediate value.

In the embodiment depicted in FIG. 1, the second arm 106 can be connected, and in some embodiments, pivotably connected, to the link arm 110 at the first end 107 of the first arm 106 via a joint 111 that can be, for example, a compliant joint. In some embodiments, the joint 111 can allow the rotational displacement of the second end 109 of the second arm 106 with respect to the first end 107 of the second arm 106. This can likewise affect the relative position of the first arm 104 with respect to the second arm 106 and/or the distance between the first arm 104 and the second arm 106, and particularly can affect the relative position of the second end 109 of the second arm 106 with respect to the first arm 104 and/or the second end 105 of the first arm 104 and/or the distance between the second end 109 of the second arm 106 and the first arm 104 and/or the second end 105 of the first arm 104.

This connection of the first arm 104, the second arm 106, and the link arm 110 can create a U-shaped flossing head 102. In some embodiments, the connection of the leading arm 104, the trailing arm 106, and link arm 110 can give other shapes to the flossing head 102 such as, for example, a C-shape, a trapezoidal shape, or the like.

In some embodiments, the filament 108 can be a thin single fiber and/or group of fibers that is/are sized, shaped, and configured for insertion between the patient's teeth into, for example, the interproximal space. This filament 108 can comprise any lubricious fiber sufficiently strong and thin to be used for dental hygiene. In some embodiments, the filament 108 can comprise any dental floss including, for example, a waxed fiber such as a nylon or cotton fiber, a polytetrafluoroethylene (PTFE) fiber, an ultra-high-molecular-weight polyethylene (UHMPE) fiber, or any other fiber. In some embodiments, the filament 108 can comprise dental floss.

As seen in FIG. 1, some or all of the first arm 104, the second arm 106 and the link arm 110 can include one or several tiers 112. In some embodiments, the one or several tiers 112 can improve the appearance of the flossing head 102 and increase the rigidity of the flossing head 102. In some embodiments, the increased rigidity of the flossing head 102 can decrease the likelihood of bending and/or deformation of one of the leading arm 104, the trailing arm 106, and the link arm 110 during flossing.

As further seen in FIG. 1, in some embodiments, the link arm 110 can include a bite plate 114. In some embodiments, the bite plate 114 can be sized, shaped, and positioned so as to allow a user to bite on the bite plate 114 to increase the force with which the filament 108 is pushed between teeth during flossing. In some embodiments, the bite plate 114 can comprise a thickness and/or width that is greater than the thickness and/or width of the link arm 110. In some embodiments, this increased thickness and/or width of the bite plate 114 can increase stability of the hybrid dental tool 100 when a user is biting on the bite plate 114. In some embodiments, the bite plate 114 can extend parallel to the filament 108.

The flosser 101 can include a handle portion 116. In some embodiments, the handle portion 116 can be sized and shaped so as to allow a user to hold the handle portion 116 to control operation of the hybrid dental device 100. The handle portion 116 can include a connecting end 118 that connects to the flossing head 102, and specifically can connect to one or more of the link arm 110 and the trailing arm 106. The handle portion 116 can further include a free end 120. In some embodiments, the free end 120 is located opposite the connecting end 118, and does not directly connect to the flossing head 102, but rather connects to the flossing head 102 via the connecting end 118.

As seen in FIG. 1, the handle portion 116 includes a pick receptacle 122 extending from the free end 120 towards the connecting end 118. The pick receptacle 122 can be configured to receive an/or retain a pick 124 that can, in some embodiments, have a first end 126 and a second end 128. In some embodiments, the pick receptacle 122 can be sized so as to receive the pick 124, and specifically can have one or several dimensions larger than one or several corresponding dimensions of the pick 124 so as to thereby allow portions of the pick 124 to be received within the pick receptacle 122. In some embodiments, the pick receptacle 122 can comprise a contour of the handle 116 that corresponds to a contour of the pick 124, which contour allows the use of the flosser 101 whether or not the pick 124 is attached to the handle 116.

In some embodiments, and as seen FIG. 1, the pick receptacle 122 extends from the free end 120 of the handle 116 towards the connecting end 118 of the handle 116. The pick receptacle 122 can be shaped such that the first end 126 of the pick 124 is relatively more proximate to the connecting end 118 of the handle 116, and the second end 128 of the pick 124 is relatively more proximate to the free end 120 of the handle 116. In some embodiments, the pick receptacle 122 can be sized to be smaller than the pick 124 and/or so that one or several dimensions of the pick receptacle 122 are smaller than the corresponding one or several dimensions of the pick 124 to thereby create a friction fit and/or interference fit. In some embodiments, this interference fit can result in deformations to some or all of the pick receptacle 122 and/or the pick 124, which deformations can retain the pick 124 within the pick receptacle 122.

The flosser 101 can, in some embodiments, include a lever 130 that can have a first end 132 and a second end 134. In some embodiments, the first end 132 of the lever 130 can be connected to the second arm 106, and specifically to the first end 107 of the second arm 106. The lever 130 can be used to move the second arm 106 from a first position to a second position. In some embodiments, the lever 130 can be spaced from the handle 116 to allow movement of the lever 130, which can result in the movement of the second arm 106, and can be specifically spaced from the handle 116 to allow movement of the lever 130 and the thereto connected second arm 106 from the first position to the second position. In some embodiments, this movement can be facilitated by a gap 136 that can be defined, in part, by the handle 116, the link arm 110, the second arm 106, and the lever 130.

In some embodiments, the flosser 101 can include one or several lock features 138, also referred to herein as locking features 138, locking element 138, and/or lock element 138, that can secure and/or lock the lever 130 and the thereto connected second arm 106 in one or both of the first position and the second position, allowing the locking of the filament 108 in one or both of the first and second tensions/tension positions and/or the first and second arms 104, 106 in one or both of the first and second relative positions. In some embodiments, the locking features 138 can be configured to lock and/or unlock the lever 130, the second arm 106, the position of the second arm 106, the relative position of the first and/or second arms 104, 106, and/or the tension position of the filament 108. In some embodiments, the locking features 138 can be configured to allow the repeated locking and/or unlocking of the lever 130, the second arm 106, the position of the second arm 106, the relative position of the first and/or second arms 104, 106, and/or the tension position of the filament 108. The locking features 138 can include one or several features that can maintain a position of one or several components of the flosser 101, including, for example, features that mechanically maintain and/or magnetically maintain a position of one or several components of the flosser 101. These features can include, one or several magnets, snaps, clips, locks, force-fitting pieces, ratcheting features, or the like.

In some embodiments, and as depicted in FIG. 1, these locking features 138 can be located, for example, in part on the handle 116 and/or in part on the lever 130. Thus, in one embodiment, a first portion of the locking element 138 can be located on the lever 130 and a second portion of the locking element 138 can be located on the handle 116. In the specific embodiment of FIG. 1, the locking features 138 include a ball 140 located on the lever 130, and specifically located proximate to the second end 134 of the lever 130, and a socket 142 located on the handle 116, and specifically located at an intermediate position between the connecting end 118 and the free end 120 of the handle 116.

In some embodiments, the socket 142 can have lips 144 that are separated by a distance D1. In some embodiments, the distance D1 can be smaller than the diameter of the ball 140 to thereby retain the ball within the socket 142. In such an embodiment, the lips 144 and/or the ball 140 can be configured to deform, including to elastically deform, when an adequate pressure is applied to the ball 140 and/or the lips 144. In some embodiments, this deformation can allow the movement of the ball 140 into and/or out of a capture volume 146 defined by the socket 142. In some embodiments, the lips 144 and/or the ball 140 can be rigid so as to prevent deformation of one or both of the ball 140 and/or the lips 144. In such an embodiment, the ball 140 can enter into the capture volume 146 other than through the lips 144. In the embodiment of FIG. 1, for example, the ball 140 can enter and/or be removed from the capture volume 146 from the side, in a direction normal to the front view shown in FIG. 1.

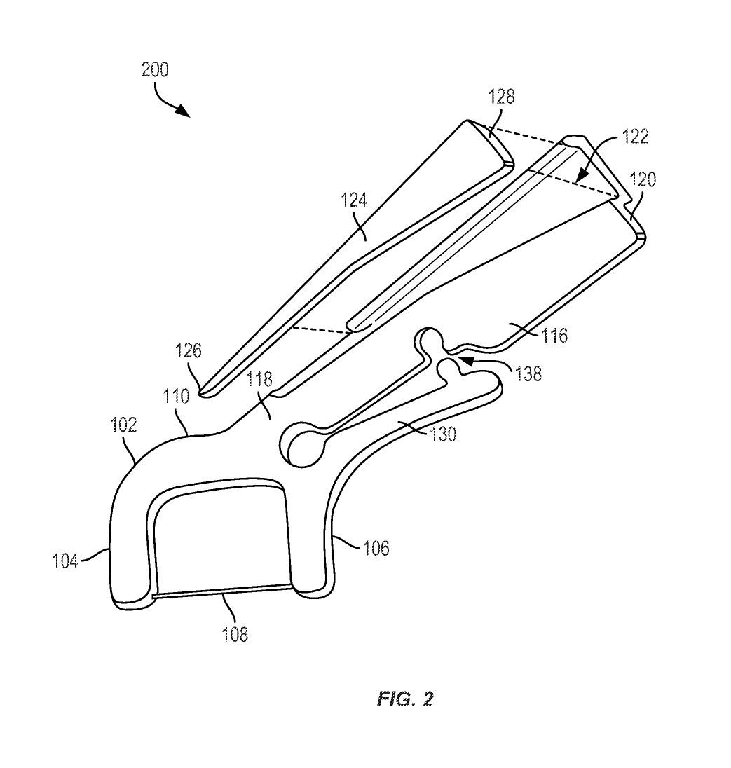

With reference now to FIG. 2, a perspective view of an embodiment of a lockable tensioning flosser 200 is shown. This lockable tensioning flosser 200 includes the flossing head 102 having the first arm 104 and the second arm 106 connected by the first filament 108 and the link arm 110. The second arm 106 is pivotably connected to the link arm 110, and is connected to lever 130. Extending from the flossing head is handle 116. Locking features 138 are located, in part, on the handle 116 and on the lever 130 and allow the locking of the second arm 106 in one or several positions.

The handle 116 can be sized and shaped so as to allow a user to hold the handle 116 to control operation of the lockable tensioning flosser 200. In some embodiments, the handle 116 can be made of the same material as the flossing head 102, and in some embodiments, the handle 116 can be made of a different material than the flossing head 102. The handle 116 can include a connecting end 118 that connects to the flossing head 102, and specifically can connect to one or more of the link arm 110 and the second arm 106. The handle 116 can further include a free end 120. In some embodiments, the free end 120 is located opposite the connecting end 118, and does not directly connect to the flossing head 102, but rather connects to the flossing head 102 via the connecting end 118.

The handle 116 can include the pick receptacle 122. In the embodiment depicted in FIG. 2, the pick receptacle 122 extends from the free end 120 of the handle 116 towards the connecting end 118 of the handle. The pick receptacle 122 can be shaped such that the first end 126 of the pick 124 is relatively more proximate to the connecting end 118 of the handle 116, and the second end 128 of the pick 124 is relatively more proximate to the free end 120 of the handle 116. In some embodiments, the pick receptacle 122 can be sized to be smaller than the pick 124 and/or so that one or several dimensions of the pick receptacle 122 are smaller than the corresponding one or several dimensions of the pick 124 to thereby create a friction fit and/or interference fit. In some embodiments, this interference fit can result in deformations to some or all of the pick receptacle 122 and/or the pick 124, which deformations can retain the pick 124 within the pick receptacle 122.

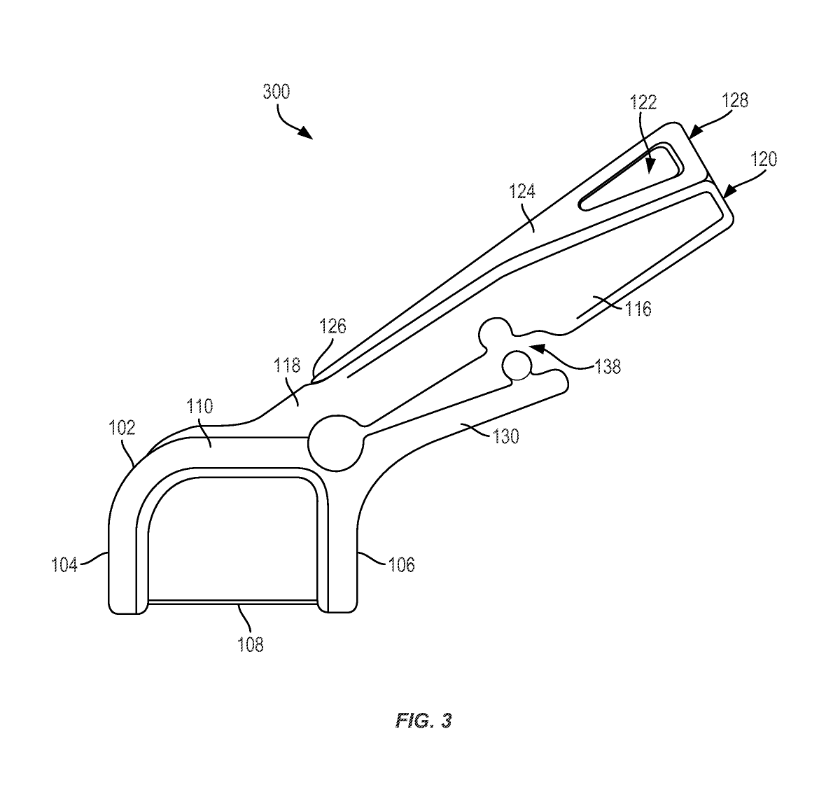

With reference now to FIG. 3, a front view of an embodiment of a lockable tensioning flosser 300 is shown. This lockable tensioning flosser 300 includes the flossing head 102 having the first arm 104 and the second arm 106 connected by the first filament 108 and the link arm 110. The second arm 106 is pivotably connected to the link arm 110, and is connected to lever 130. Extending from the flossing head is handle 116. Locking features 138 are located, in part, on the handle 116 and on the lever 130 and allow the locking of the second arm 106 in one or several positions.

Extending from the flossing head is handle 116. The handle 116 can be sized and shaped so as to allow a user to hold the handle 116 to control operation of the lockable tensioning flosser 300. In some embodiments, the handle 116 can be made of the same material as the flossing head 102, and in some embodiments, the handle 116 can be made of a different material than the flossing head 102. The handle 116 can include a connecting end 118 that connects to the flossing head 102, and specifically can connect to one or more of the link arm 110 and the second arm 106. The handle 116 can further include a free end 120. In some embodiments, the free end 120 is located opposite the connecting end 118, and does not directly connect to the flossing head 102, but rather connects to the flossing head 102 via the connecting end 118.

The handle 116 can include the pick receptacle 122 and one or several connecting features 302, also referred to herein as connecting features 302, that are configured to matingly engage with one or several features of the pick 124 to releasably secure the pick 124 within the pick receptacle 120 and/or to the handle 116. In some embodiments, the mating engagement of the connecting features 302 with corresponding features of the pick 124 can allow the repeatable securement of the pick 124 within the pick receptacle 122 and/or to the handle 116, and in some embodiments, the mating engagement of the connecting features 302 with corresponding features of the pick 124 may not allow the repeatable securement of the pick 124 within the pick receptacle 122 and/or to the handle 116.

In the embodiment depicted in FIG. 3, the pick receptacle 122 extends from the free end 120 of the handle 116 towards the connecting end 118 of the handle 116. The pick receptacle 122 can be shaped such that the first end 126 of the pick 124 is relatively more proximate to the connecting end 118 of the handle 116, and the second end 128 of the pick 124 is relatively more proximate to the free end 120 of the handle 116.

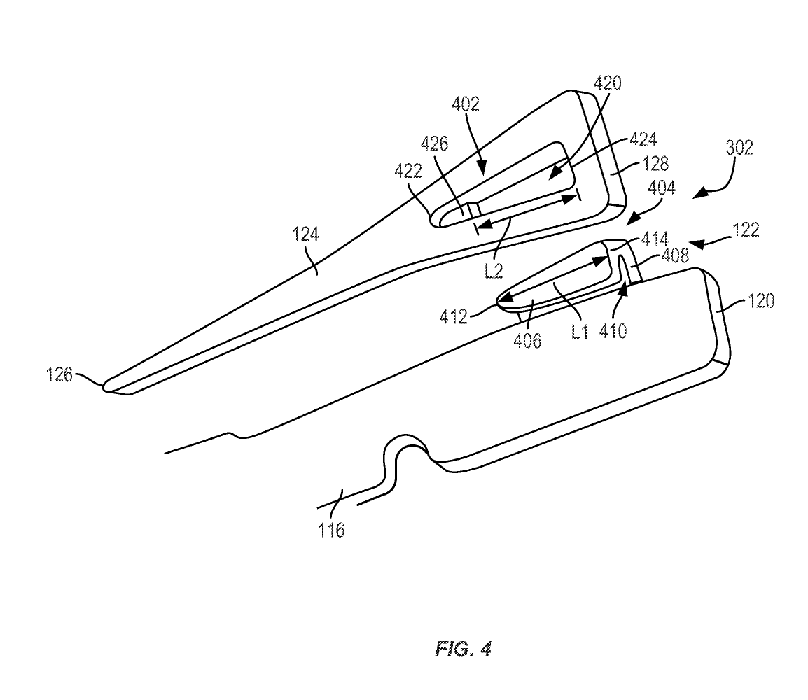

With reference now to FIG. 4, a close-up perspective view of the connecting features 302 and one or several mating features 402 of the pick 124 that can be configured to matingly engage with the connection features 302 of the flosser 101 is shown.

The connecting features 302 include a male insert 404 having a front portion 406 and a back portion 408 that are partially separated by a void 410. The male insert 404 further includes a first end 412 and an opposing second end 414. The first end 412 and the second end 414 are separated by a distance L1.

The mating features 402 include a female receptacle 420 that is sized and shaped to receive the male insert 404. The female receptacle 420 has a first end 422 and a second end 424. A retention tab 426 is located at the first end 422 of the female receptacle 420. The retention tab 426 is sized and shaped to be, at least partially, received within the void 410 of the connecting features 302. As depicted in FIG. 4, the distance between the retention tab 426 and the second end 424 of the female receptacle 420 is defined by a distance L2. In some embodiments, distance L2 can be greater than and/or equal to distance L1 to thereby allow the male insert 404 to be received within the female receptacle 420. In such an embodiment, after the male insert 404 has been received in the female receptacle 420, the male insert 404, and the thereto connected pick 124, can be slid relatively towards the retention tab 426 and/or the first end 422 of the female receptacle 420. This motion of the male insert 404 with respect to the female receptacle 420 can result in the retention tab 426 being at least partially received within the void 410 such that the front portion 406 is on one side of the retention tab 426 and the back portion 408 is on the other, opposite side of the retention tab 426. This positioning secures the male insert 404, and thereby the pick 124, with respect to the flosser 101.

While various embodiments of present invention have been described, it will be apparent to those of skill in the art that many more embodiments and implementations are possible that are within the scope of this invention. Accordingly, the present invention is not to be limited to the described embodiments.

What is claimed is:

1. A dental flosser comprising:
a flossing head comprising:
a first arm extending in a first direction;
a second arm extending in the first direction;
a linking arm connecting the first arm and the second arm; and
a filament extending from the first arm to the second arm;
wherein the first arm and the second arm are movable from a first relative position to a second relative position to thereby adjust a tension of the filament from a first tension to a second tension, wherein the filament is loose at the first tension and taut at the second tension, and wherein the first and second arms are lockable in the second relative position.

2. The dental flosser of claim 1, wherein the first arm comprises a first end connecting to the linking arm, and a second end from which the filament extends.

3. The dental flosser of claim 2, wherein the second arm comprises a first end connecting to the linking arm, and a second end from which the filament extends.

4. The dental flosser of claim 3, wherein the first end of the second arm is pivotably connected to the linking arm.

5. The dental flosser of claim 4, wherein the first arm and the second arm are movable from the first relative position to the second relative position by rotationally displacing the second end of the second arm about the pivotable connection of the first end of the second arm to the linking arm.

6. The dental flosser of claim 1, wherein the first arm and the second arm are separated by a first distance when in the first position and wherein the first arm and the second arm are separated by a second distance when in the second position.

7. The dental flosser of claim 6, wherein the second distance is between 0 and 20 percent larger than the first distance.

8. The dental flosser of claim 1, wherein the first and second arms are repeatably lockable in the second relative position, and wherein the first and second arms can be released from the locked, second relative position.

9. A dental flosser comprising:
a flossing head having:
a linking arm;
a first arm rigidly connecting to the linking arm and extending in a first direction from the linking arm;
a second arm comprising a compliant joint, wherein the second arm is connected to the linking arm via the compliant joint, wherein the second arm extends from the linking arm in the first direction, and wherein the second arm is moveable from a first position to a second position; and
a filament extending from the first arm to the second arm, wherein a tension of the filament is adjustable from a first tension to a second tension when the second arm is moved from the first position to the second position.

10. The dental flosser of claim 9, wherein the second arm comprises a first end connecting to the linking arm via the compliant joint, and a second end from which the filament extends.

11. The dental flosser of claim 10, wherein the second arm is movable from the first position to the second position by rotationally displacing the second end of the second arm about the compliant joint connecting the first end of the second arm to the linking arm.

12. The dental flosser of claim 11, wherein the first arm and the second arm are separated by a first distance when the second arm is in the first position and wherein the first arm and the second arm are separated by a second distance when the second arm is in the second position.

13. The dental flosser of claim 12, wherein the second distance is approximately 15 percent larger than the first distance.

14. The dental flosser of claim 9, further comprising a locking element configured to secure the second arm in the second position.

15. The dental flosser of claim 14, wherein the locking element can releasably secure the second arm in the second position.

16. The dental flosser of claim 14, wherein the second arm further comprises a lever connecting to the second arm via a first end.

17. The dental flosser of claim 16, further comprising a handle extending from the linking arm.

18. The dental flosser of claim 17, wherein a first portion of the locking element is located at a second end of the lever arm and a second portion of the locking element is located on the handle.

19. The dental flosser of claim 18, wherein first portion of the locking element comprises one of a ball and a socket.

20. The dental flosser of claim 19, wherein the second portion of the locking element comprises the other of the ball and the socket.
